(19) United States
(12) Patent Application Publication
(10) Pub. No.: US 2025/0111206 A1
(43) Pub. Date: Apr. 3, 2025

(54) PROBABILISTIC LOGICAL NEURAL NETWORK WITH INTERPRETABLE PARAMETERS

(71) Applicant: INTERNATIONAL BUSINESS MACHINES CORPORATION, ARMONK, NY (US)

(72) Inventors: Naweed Aghmad Khan, Johannesburg (ZA); Jonathan Lenchner, Greenwich, CT (US); Ismail Yunus Akhalwaya, Emmarentia (ZA); Ryan Nelson Riegel, Carrollton, GA (US); Alexander Gray, Yonkers, NY (US)

(21) Appl. No.: 18/477,575

(22) Filed: Sep. 29, 2023

(51) Int. Cl. G06N 3/047; G06N 3/048; G06N 3/082; G06N 3/084

(52) U.S. Cl. CPC G06N 3/047; G06N 3/048; G06N 3/082; G06N 3/084

(57) ABSTRACT

A method, computer system, and a computer program product are provided. Inferencing is performed with a probabilistic logical neural network. The probabilistic logical neural network includes a probabilistic graphical model that includes propositional nodes, logical operational nodes, and directed edges. The directed edges indicate a direction of upward inference. The downward inference is in an opposite direction from that of the directed edges. The probabilistic logical neural network implements upward and downward inference. The propositional and logical operational nodes are coupled with respective belief bounds. Each of the logical operational nodes includes a respective activation function set to a probability-respecting generalization of the Fréchet inequalities.

### BACKGROUND

The present invention relates generally to the fields of machine learning models, inner design of machine learning models, training of machine learning models, and performing inference tasks by machine learning models.

### SUMMARY

According to one exemplary embodiment, a computer-implemented method is provided. Inferencing is performed with a probabilistic logical neural network. The probabilistic logical neural network includes a probabilistic graphical model that includes propositional nodes, logical operator nodes, and directed edges. The probabilistic logical neural network implements upward and downward inference. The directed edges indicate a direction of upward inference. The downward inference is in an opposite direction from that of the directed edges. The propositional and logical operator nodes are coupled with respective belief bounds. Each of the logical operator nodes includes a respective activation function set to a probability-respecting generalization of the Fréchet inequalities. A computer system and computer program product corresponding to the above method are also disclosed herein.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a snippet of a probabilistic logical neural network (PLNN) according to at least one embodiment;

FIG. 2 illustrates a larger snippet of a probabilistic logical neural network according to at least one other embodiment;

FIG. 3 illustrates Venn Diagrams showing aspects behind the Fréchet inequalities which are related to aspects of the probabilistic logical neural network according to at least one embodiment;

FIG. 4A illustrates PLNN upward inference taking upper and lower bounds into consideration according to at least one embodiment;

FIG. 4B illustrates PLNN downward inference taking upper and lower bounds into consideration according to at least one embodiment;

FIG. 5A illustrates PLNN upward inference taking upper and lower bounds and neural network weights into consideration according to at least one embodiment;

FIG. 5B illustrates PLNN downward inference taking upper and lower bounds and neural network weights into consideration according to at least one embodiment;

FIG. 6 illustrates a PLNN training and computation process according to at least one embodiment;

FIG. 7 illustrates aspects of a node spawning process that according to at least one embodiment can be part of the PLNN training and computation process shown in FIG. 6;

FIG. 8 illustrates aspects of various computational nodes and node combinations that are part of a PLNN according to at least some embodiments; and

FIG. 9 illustrates a networked computer environment in which probabilistic logical neural network training and inference are implemented according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The following described exemplary embodiments provide a computer system, a method, and a computer program product for training and using an improved machine learning model that integrates inductive reasoning (e.g., in a manner of a neural network and/or based on statistics), deductive reasoning, and probabilistic reasoning and includes one or more of the following features and/or advantages. The improved machine learning model described herein is able to make inferences on systems for which little training data is provided and/or for which there is a lot of data available to train parts of a network but small amounts of data to train other parts of the network. In that instance the improved machine learning model is able to use a sound logical theory about the low-data area to compensate for the low amounts of data. Thus, the machine learning model described herein has greater effectiveness in inferencing for states that are largely unobserved. The improved machine learning model is more explainable than traditional neural networks and allows for interpretation of weights associated with edges of a classical neural network. The present embodiments enhance the framework of a logical neural network by achieving probabilistic interpretation for operational nodes instead of fixing a particular fuzzy logic at each operational node. The enhanced machine learning model allows for logical combinations of probabilistic assertions and accommodates bounded beliefs. The enhanced machine learning model directly expresses degrees of uncertainty among variables, e.g., correlation and/or anti-correlation and independence. This expression occurs via a new parameter (e.g., a relative correlation coefficient, that is herein called the “J” parameter). The enhanced machine learning model achieves greater probability awareness and does not need to rely on or use full conditional probability tables. The enhanced machine learning model is able to integrate with traditional neural networks and their implementation of end-to-end backpropagation. The present embodiments implement an upward and downward inference strategy and couple this strategy with belief bounds via setting an activation function to a probability-respecting generalization of the Fréchet inequalities. The activation function is set for a respective logical operator associated with each operational node of the enhanced machine learning model. The enhanced machine learning model uses the relative correlation coefficient (which more tightly bounds the probability-respecting generalization of the Fréchet inequalities) as input and also provides it as output at all operational (logical) nodes. The enhanced machine learning model takes the belief bounds as both input and output. The enhanced machine learning model allows any of its nodes to function as a labeled node. The enhanced machine learning model is able to take an entire neural network as input and allow the user to specify logical relations among nodes of the neural network or nodes that are part of the enhanced machine learning model but not part of the neural network. The improved machine learning model described herein is referred to herein as a probabilistic logical neural network (“PLNN”).

The Fréchet inequalities, also known as the Boole-Fréchet inequalities, govern the combination of probabilities about logical propositions or events logically linked together in conjunctions (AND operations) or disjunctions (OR operations). These inequalities can be considered rules about how to bound calculations involving probabilities without assuming independence or without making any dependence assumptions whatsoever. If Aᵢ are logical propositions or events, the Fréchet inequalities are:
Probability of a logical conjunction (∧)

$$max ( 0 , {\sum }_{k = 1}^{n} P ( {A}_{k} ) - ( n - 1 ) ) \leq P ( {⋀}_{k = 1}^{n} {A}_{k} ) \leq {min}_{k} \{ P ( {A}_{k} ) \}$$

Probability of a logical disjunction (∨)

$${max}_{k} \{ P ( {A}_{k} \} \leq P ( {⋁}_{k = 1}^{n} {A}_{k} ) \leq min ( 1 , {\sum }_{k = 1}^{n} P ( {A}_{k} ) )$$

where P( ) denotes the probability of an event or proposition. In the case where there are only two events (say A and B), the inequalities reduce to:
Probability of a logical conjunction (∧)

$$max ( 0 , P ( A ) + P ( B ) - 1 ) \leq P ( A ∧ B ) \leq min ( P ( A ) , P ( B )$$

Probability of a logical disjunction (∨)

$$max ( P ( A ) , P ( B ) ) \leq P ( A ∨ B ) \leq min ( 1 , P ( A ) + P ( B ) ) .$$

These Fréchet inequalities are discussed in the article Fréchet, M. (1935). “Généralisations du théorème des probabilités totals”, Fundamental Mathematicae 25: 379-387.

The enhanced machine learning model PLNN described herein is especially suitable for implementation in conditions of multi-agent reinforcement learning. In a system with multi-agent reinforcement learning, multiple agents coexist and compete for shared resources. The PLNN is implementable in multi-agent reinforcement learning applied to real-world problems to better perform predictions in conditions of partial observability and uncertainty. The PLNN improves with sample efficiency and interpretability. The PLNN described herein permits accurate inference for variables with unobserved states. The PLNN in some embodiments is applied to perform and optimize different tasks such as workload routing in a system-on-chip for a computer, medical diagnosis or treatment, workload routing in the cloud, hallucination avoidance in foundation models, analyzing argumentation frameworks in intelligence briefing documents, engagement actions for a self-driving vehicle or hybrid self-driving/user-driven vehicle, emergency responses in unfamiliar environments, etc. The enhanced machine learning model PLNN is better able to analyze input from a multi-faceted network and control automated actions and/or provide predictions of appropriate steps to take based on the input.

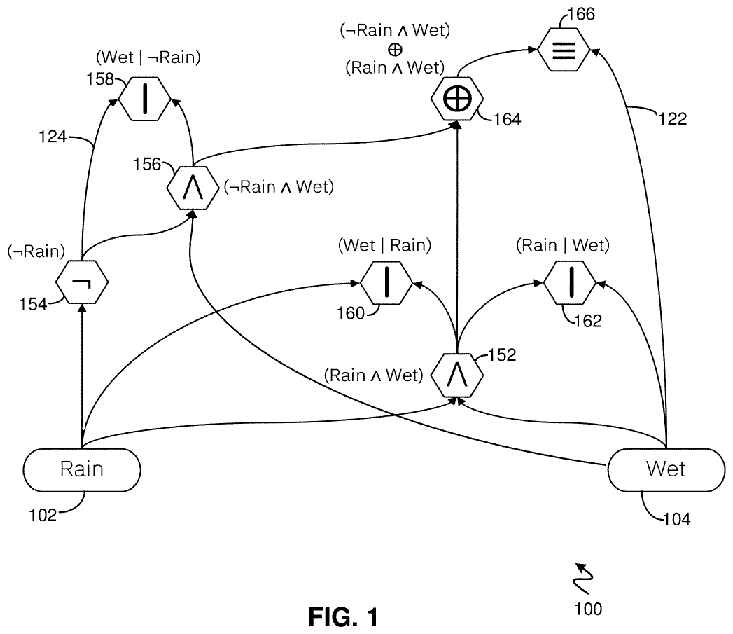

FIG. 1 illustrates a first snippet 100 of a PLNN and illustrates node types and node connections that are part of the PLNN. A PLNN is a logical-probabilistic graphical model that is defined to be a 4-tuple P=(V, E, B, J) (not including the edge weights) or a 5-tuple P=(V, E, B, J, W) (where weights are included). One of the tuples, V, is a finite collection of vertices or nodes. The nodes are partitioned into two groups: (1) propositional nodes and (2) operational nodes. In the first snippet 100 shown in FIG. 1, the propositional nodes (two of them shown) are labeled with label numbers that are less than 110 and the propositional nodes (eight of them shown) are labeled with label numbers that are greater than 150.

The propositional nodes are associated with elementary events without any logical connectives between them. The propositional nodes are associated with primitive assertions about the state of the world. For example, the first propositional node 102 of the first snippet 100 shown in FIG. 1 is associated with the assertion that “it will rain tomorrow” in a particular area. The second propositional node 104 of the first snippet 100 shown in FIG. 1 is associated with the assertion that “the grass (in some particular area) will be wet tomorrow”.

The operational nodes are associated with logical operations such as ∧ (and), ∨ (or), ¬ (not), →, (if then), ≡ (identity), and | (conditional). The first PLNN snippet 100, FIG. 1, shows a first operational node 152 which is an ∧ “and” and includes two propositional nodes as input. Based on the definition in this example of first and second propositional nodes 102, 104 the first operational node 152 represents a range of probabilities (with an upper bound a lower bound) that both assertions of the first and second propositional nodes 102, 104 are/will be true, namely that tomorrow it will both rain in the particular area and the patch of grass in that particular area will be wet. Given ranges of probabilities for the first and second propositional nodes 102, 104, these ranges of probabilities are able to be input into the first operational node 152 in order to bound the probability of this “and” condition occurring. The second operational node 154 includes the “not” or negation symbol and includes the input from the first propositional node 102. The second operational node 154 represents a computation that it will not rain tomorrow and is able to be computed via one minus the input probability from first operational node 152 (if there is a 55% chance it will rain tomorrow there is a 45% chance it will not rain tomorrow or with belief bounds if there is a 55 to 60% chance it will rain tomorrow there is a 40 to 45% chance that it will not rain tomorrow). The third operational node 156 includes an “and” symbol and includes one propositional value and one logical operator value as input, in this example the output of the first propositional node 102 and the output of second operational node 154. Thus, in this example the third operational node 156 represents the probability that both (A) the negation (output from the second operational node 154) of the first propositional node 102 (it will rain in this area tomorrow) is true (in other words whether it is true that it will not rain in this area tomorrow) and (B) the second propositional node 104 (the grass patch in this area will be wet tomorrow) is also true. Given probability bounds for the second operation node 154 and the second propositional node 104, they become inputs into the third operational node 156 in order to calculate the probability bounds of this A “and” condition occurring.

The fourth, fifth, and sixth operation nodes 158, 160, 162 shown in the first snippet 100 of the PLNN in FIG. 1 represent a special symbol, |, used to represent the conditional probability that one argument holds, given that a second argument holds. An important nuance is that the inputs to the conditional (A|B) are not A and B but A∧B and B since for known probabilities p(B) and p(A∧B), the probability of the conditional p(A|B) is defined to be p(A∧B)/p(B). These conditional, |, operational nodes have ranges of belief bounds, as was described above for the other operation nodes.

The fourth operation node 158 in this example indicates the probability (expressed in a range) of whether the grass in a particular patch will be wet tomorrow given that there is no rain tomorrow. Thus, the inputs to the fourth operation node 158 are the not rain probability from the second operational node 154 and the output of the third operational node 156 representing not rain “and” wet conditions. The fourth operation node 158 is computed by determining the probability of both the grass being wet and it not raining, with that determined “and” value being divided by the probability that it will not rain tomorrow.

The fifth operation node 160 in this example indicates the probability (expressed in a range of belief bounds) of whether the grass in a particular patch will be wet tomorrow given that there is rain tomorrow. Thus, the inputs to the fifth operation node 160 are the rain probability from the first proposition node 102 and the output of the first operational node 152 representing rain “and” wet conditions. The fifth operation node 160 is computed by determining the probability of both the grass being wet tomorrow and that it will rain tomorrow, with that determined “and” value being divided by the probability that it rains tomorrow.

The sixth operation node 162 in this example indicates the probability (expressed in a range of belief bounds) of whether it will rain tomorrow given that grass in a particular patch will be wet tomorrow. The inputs to the sixth operation node 162 are the wetness probability from the second proposition node 104 and the output of the first operational node 152 representing rain “and” wet conditions. The sixth operation node 162 is computed by determining the probability of both it raining tomorrow and the grass being wet tomorrow, with that determined “and” value being divided by the probability that the grass will be wet tomorrow.

The seventh operation node 164 shown in the first snippet 100 of the PLNN in FIG. 1 represents a special symbol ⊕ used to represent disjunction when two input variables cannot occur simultaneously and are therefore mutually exclusive, meaning that the relative correlation coefficient J is equal to −1. In this example, the seventh operation node 164 includes two inputs—one from the first operation node 152 (for rain and wet) and another from the third operation node 156 (for not rain and wet). Because it is impossible for it to both be raining and not raining in the same area under examination, the ⊕ symbol indicates mutual exclusivity of the two inputs.

The eighth operation node 166 shown in the first snippet 100 of the PLNN in FIG. 1 represents the logical symbol ≡ (equivalence). The eighth operation node 166 receives inputs from two different nodes and indicates that these two different sets of bounds should be set equal to each other. In this particular example, the eighth operation node 166 represents a consequence of the probabilistic law of marginalization: if one would like to know the probability of B regardless of the value of A, one can add the probabilities of A∧B and ¬A∧B. Thus, in this example the eighth operation node 166 receives the inputs from the seventh operation node 164 (⊕) and from the second proposition node 104 (wet) and indicates that they should be set equal to each other. In PLNN this is implemented by taking the highest lower bound of either input node and the lower upper bound and assigning these bounds to the equality or equivalence node. (This assignment of bounds occurs in the “upward inferencing” pass, as will subsequently be described herein. On the downward pass, these bounds are then passed down to the respective input nodes (nodes 164 and 104).)

The first snippet 100 of the PLNN in FIG. 1 also shows that the PLNN includes directed edges between the nodes. The set of edges are the E element of the PLNN tuple (for both the 4-tuple and 5-tuple embodiments). The PLNN includes directed edges that respectively point either from a propositional node to an operational node or from an operational node to another operational node. In the first snippet 100, a first edge 122 (of the first directed edge type described above) points from a propositional node to an operational node (namely from the second propositional node 104 to the eighth operation node 166). A second edge 124 (of the second directed edge type described above) points from an operation node to another operation node (namely from the second operation node 154 to the fourth operation node 158). Other directed edges are shown in first snippet 100 but are not labelled.

The B element of the PLNN tuple is a set of belief bounds associated with each individual node in the PLNN. Each individual node in the set V includes a respective lower bound lᵥ and a respective upper bound uᵥ. The range 0≤lᵥ≤uᵥ≤1 describes the belief of the system/PLNN about the range of probabilities that an individual node can take on.

The J element of the PLNN tuple is a set of relative correlation coefficients that are associated with the operational nodes ∧ (and), ∨ (or), and →, (implication), with a particular respective J value associated with each of those operational nodes. These coefficients are also specified using bounds but with the lower bound and the upper bound ranging in [−1, 1]. For the mutually exclusive disjunction nodes ⊕ the relative correlation coefficient J is equal to −1. ⊕ is a symbol used for convenience because the case of mutually exclusive disjunction comes up so frequently. J=1 refers to a condition of maximum correlation between two input nodes given fixed marginal probabilities for the input nodes. J=−1 refers to a condition of maximum anti-correlation between two nodes given fixed marginal probabilities.

In at least some embodiments, the PLNN is a 5-tuple of P=(V, E, B, J, W). In these embodiments, the W element of the tuple (the fifth element) is a set of real-valued weights that are associated with any of the edges, with a particular respective weight (W value) associated with each of the edges.

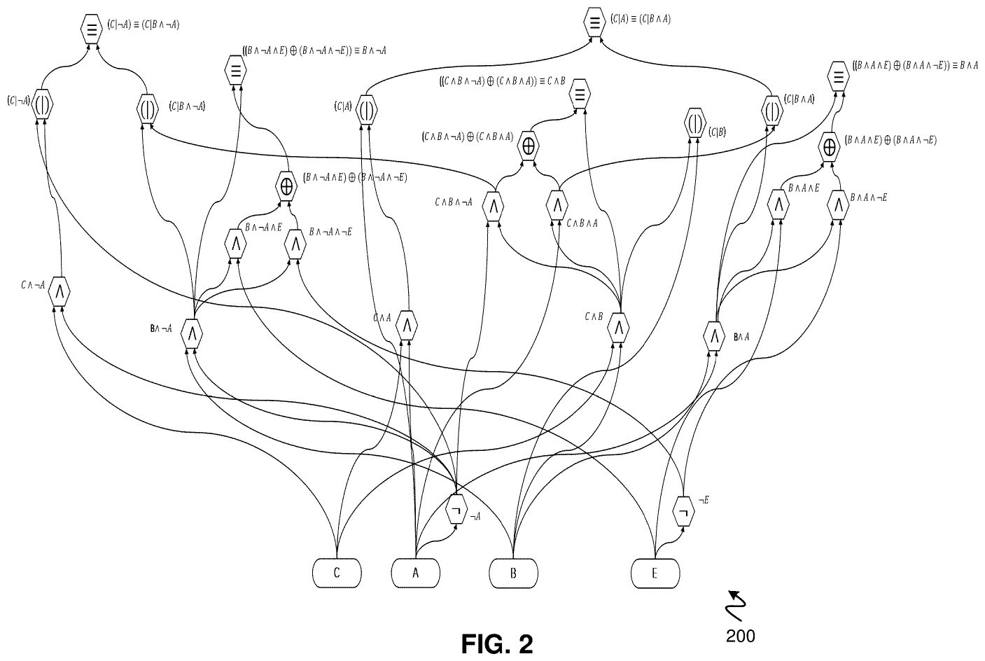

FIG. 2 shows a second snippet 200 of a PLNN. The second snippet 200 is larger than the first snippet 100 shown in FIG. 1. The second snippet 200 includes four propositional nodes A, B, C, and D. Various directed edges and operational nodes are shown as part of the larger PLNN portion (second snippet 200). The second snippet 200, also differently from the first snippet 100, shows nodes with more than two inputs, e.g., with inputs from more than two propositional nodes.

A PLNN has the feature that each conditional probability is represented as its own node. Thus, the first snippet 100 and the second snippet 200 illustrate an advantage of the PLNN that it has a greater variety of node types as explained above. This division into separate nodes is done in place of needing a conditional probability table for each node, as is done for example in Bayesian networks.

For the PLNN, the activation function for a given logical operator associated with an operational node, is set to a probability-respecting generalization of the Fréchet inequalities. Given two propositional nodes P and Q with associated beliefs or probabilities p(P) and p(Q) it is not immediately known what one's associated beliefs are about the conditions of P∨(or) Q (disjunction), P∧(and) Q (conjunction), or if P then Q (→), are. However, these beliefs can be bounded and the Fréchet inequalities provide such bounds.

### Disjunction

For the disjunction scenario, the probability of P or Q occurring (P∨(or) Q) is minimized when P and Q are maximally correlated. When P and Q are maximally correlated, the probability p(P∨(or) Q) is equal to the maximum (p(P), p(Q). The probability of P or Q occurring (P∨(or) Q) is, however, maximized when P and Q are maximally anti-correlated.

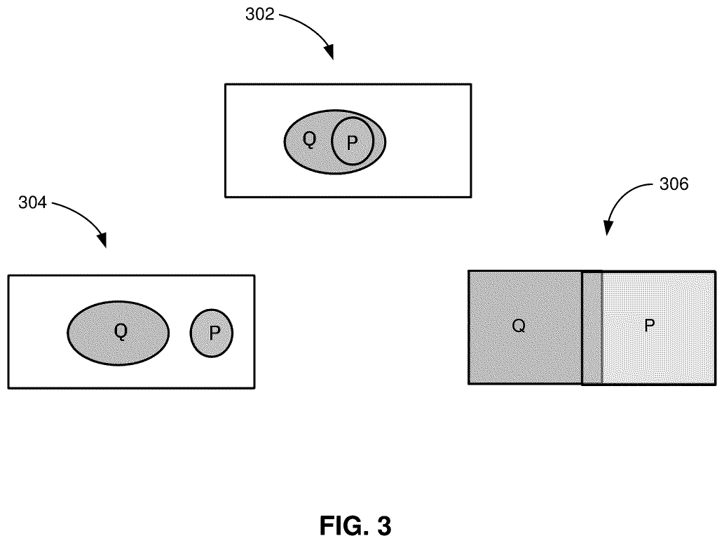

In FIG. 3, the first correlation example 302 shows an instance of P and Q being maximally correlated where the maximum of Q is greater than the maximum of P. Thus, in the first correlation example 302 the probability of p(P∨(or) Q) is equal to the probability p(Q).

When P and Q are maximally anti-correlated, the probability p(P∨(or) Q) is equal to the minimum min(1, p(P)+p(Q)). During this maximal anti-correlation, P and Q are never true together, or, if their probabilities sum to more than 1, they are true together with as small a probability as possible. The case of P and Q never being true together is depicted in the second correlation example 304 depicted in FIG. 3. The second correlation example 304 shows that the circle of P never overlaps the circle of Q. The case of the probabilities of P and Q summing to more than 1, but with P and Q true together with as small a probability as possible, is depicted in the third correlation example 306 of FIG. 3. The third correlation example 306 shows that the rectangle of Q overlaps with the rectangle of P just over a sliver in the central area of this Venn Diagram. With the three correlation examples 302, 304, 306, FIG. 3 depicts Venn Diagrams associated with the two propositions P and Q.

Merging the two observations shown in the Venn Diagrams of FIG. 3 from a disjunction perspective, the range of possible values for p(P∨(or) Q) is given by a two-sided inequality called the Fréchet inequality for disjunction which states that:

$$max ( p ( P ) , p ( Q ) ) \leq p ( P ∨ Q ) \leq min ( 1 , p ( P ) + p ( Q ) )$$

Moreover, with the addition of lower bounds lₓ and upper bounds uₓ for each of the propositional variables, one easily obtains lower and upper bounds for the disjunction.

### Conjunction

For the conjunction scenario, the probability of P and Q occurring (P∧(and) Q) is maximized when P and Q are maximally correlated. When P and Q are maximally correlated, the probability (P∧(and) Q) is equal to the minimum (p(P), p(Q). The probability of P or Q occurring (P∧(and) Q) is, however, minimized when P and Q are maximally anti-correlated.

In FIG. 3, the first correlation example 302 shows an instance of P and Q being maximally correlated where the maximum of Q is greater than the maximum of P. Thus, in the first correlation example 302 probability (P∧(and) Q) is equal to the minimum (p(P), p(Q) which is p(P).

When P and Q are maximally anti-correlated, the probability (P∧(and) Q) is equal to max(0, p(P)+p(Q)−1), where max( ) refers to the maximum of the two arguments. During this maximal anti-correlation, P and Q are never true together or if their probabilities sum to more than 1 they are true together with as small a probability as possible. The latter case of P and Q never being true together is depicted in the second correlation example 304 depicted in FIG. 3. The second correlation example 304 shows that the circle of P never overlaps the circle of Q. The former case of their probabilities summing to more than 1 and P and Q are true together with as small a probability as possible is depicted in the third correlation example 306 of FIG. 3.

Merging the two observations shown in the Venn Diagrams of FIG. 3 from the conjunction perspective, the range of possible values for (P∧(and) Q) is given by a two-sided inequality called the Fréchet inequality for conjunction which states that:

$$max ( 0 , p ( P ) + p ( Q ) - 1 ) \leq p ( P ∧ Q ) \leq min ( p ( P ) , p ( Q ) )$$

### If Then Logical Operator

For the →, (if then) scenario, e.g., the probability p(P→Q) (if P then Q) this implication is interpreted to be equivalent to the probability p(¬P∨Q). Thus, the disjunction formulas used above are applied here to the negation of P and to Q to determine the probability that if P then Q. These result in:

$$max ( p ( ¬ P ) , p ( Q ) ) \leq p ( ¬ P ∨ Q ) = p ( P \to Q ) \leq min ( 1 , p ( ¬ P ) + p ( Q ) )$$

### Lower and Upper Bounds

For the above conjunction, disjunction, and if then logical operators, the lower bound lᵥ is taken as the left side of the respective Fréchet inequality and the upper bound uᵥ is taken as the right side of the respective Fréchet inequality.

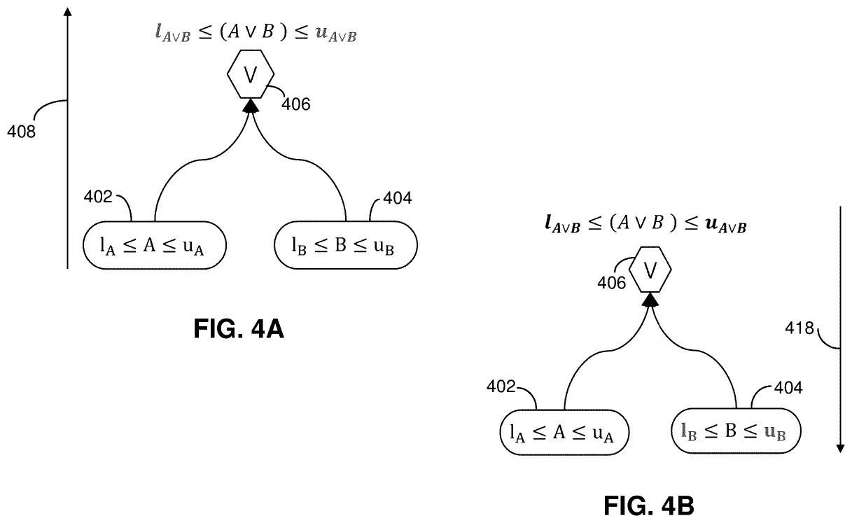

Within a PLNN, upward inference with respect to upper and lower bounds is performed as well as downward inference with respect to these bounds. FIG. 4A illustrates an example of upward inference with respect to bounds within a PLNN. FIG. 4B illustrates an example of downward inference with respect to bounds within a PLNN. Updating/determining bounds on an operational node based on bounds of its inputs is referred to as “upward inference”. This terminology of “upward” is selected due to the orientation of a PLNN in the graphical model generally having the propositional nodes towards the bottom of the paper. Upward also refers to the feedforward direction of the PLNN. Updating/determining bounds on one operand into an operational node based on the bounds of the operational node and based on the bounds of the other operands into the operational node is referred to as “downward inference”. This terminology of “downward” is analogously selected due to the orientation of a PLNN in the graphical model generally having the propositional nodes towards the bottom of the paper. Downward also refers to the backpropagation direction of the PLNN. The following provides an initial simplified discussion of upward and downward inference strategy in which use of the J parameter for interpolation of the Fréchet Inequalities is not invoked. The more complete picture in which the J parameter is part of the upward and downward inference strategy is provided after the subsequent discussion of the relative correlation coefficient J.

A computation mechanism in a PLNN is to perform successive iterations of upward and downward inferencing with respect to bounds across all nodes in the PLNN graph until successive iterations fail to tighten any bounds by more than some pre-established convergence threshold ϵ>0. The upward and downward inferencing occurs for each of the Boolean operators.

FIG. 4A illustrates the upward inference, aka upward inference with respect to bounds, being performed with the bounds of first and second bounded propositional nodes 402, 404 being used in an upwards PLNN direction 408 to determine the bounds of the first bounded operational node 406 that is an “Or” ∨ logical operator. In this bound upward inference, the lower and upper bounds for the first bounded propositional node 402 (A) are known as l_{A} and u_{A}, respectively. The lower and upper bounds for the second bounded propositional node 404 (B) are known as l_{B} and u_{B}, respectively. Using this bound information of the first and second bounded propositional nodes 402 (A), 404 (B), the bounds for the first bounded operational node 406 (V) are inferred. The lower bound of the first bounded operational node 406 (V) is equal to the lower bound l_{A} of the first propositional node 402 or the lower bound l_{B} of the second propositional node 404. Specifically, the lower bound of the first bounded operational node 406 (V) is equal to the maximum of (i) lower bound l_{A} of the first propositional node 402 and (ii) the lower bound l_{B} of the second propositional node 404. The upper bound of the first bounded operational node 406 (V) is equal to the maximum of 0 and the sum of the upper bound u_{A} of the first propositional node 402 and the upper bound u_{B} of the second propositional node 404. FIG. 4A illustrates that in a PLNN the Fréchet inequality is usable to perform upward inference to use bounds from propositional nodes to determine bounds of operational nodes. Further in the upward direction, bounds from operational nodes are usable to determine bounds of other operational nodes. Again, the term “upward” refers to a direction away from the input nodes and into the corresponding operational nodes, and also to the direction of forward propagation in the neural network.

In FIG. 4B, downward inference, aka downward inference with respect to bounds, is performed with two variations. In the first variation, the bounds of the first bounded operational node 406 (that is an “Or” ∨ logical operator) and the bounds of the first propositional node 402 are used in downward inference to infer the bounds of the second propositional node 404. In the second variation, the bounds of the first bounded operational node 406 (that is an “Or” ∧ logical operator) and the bounds of the second propositional node 404 are used in downward inference to infer the bounds of the first propositional node 402. When there are two operators both of these inferences are performed in the downward direction 418, e.g., in the direction within the PLNN towards the propositional nodes and in the direction of back propagation. FIG. 4B illustrates that in a PLNN the Fréchet inequality is usable to perform downward inference with respect to bounds to use bounds from operational nodes to determine bounds of propositional nodes. Downward inference with respect to bounds can also be used to determine bounds of operational nodes from other operational nodes.

Given known lower and upper bounds on A of l_{A} and u_{A}, lower and upper bound on A v (or) B of l_{A∨B} and u_{A∨B}, as well as some current lower and upper bounds for B of l_{B} and u_{B}, the rules for updating bounds on B in the case of disjunction are to set l_{B} to max(l_{B}, l_{A∨B}−u_{A}) and u_{B} to min(u_{B}, u_{A∨B}). The rules for updating bounds on A given known bounds on B and A v (or) B are symmetrical.

Downward inference for conjunction and implication works similarly.

The upward and downward inference update rules for the conditional (A|B) comes directly from the definition of the probability p(A|B) as p(A∧B)/p(B). For upward inference, the lower and upper bounds are obtained:

$${l}_{( A \vert B )} \to max ( {l}_{( A \vert B )} , \frac{{l}_{A ∧ B}}{{u}_{( A \vert B )}} ) and {u}_{( A \vert B )} \to min ( {u}_{( A \vert B )} , \frac{{u}_{A ∧ B}}{{l}_{( A \vert B )}} ) .$$

For downward inference, as long as p(A|B)>0, then p(B)=p(A∧B)/p(A|B). Therefore, the lower and upper bounds are obtained:

$$If {u}_{( A \vert B )} > 0 , then {l}_{B} \to max ( {l}_{B} , \frac{{l}_{A ∧ B}}{{u}_{( A \vert B )}} ) ; If {l}_{( A \vert B )} > 0 , then {u}_{B} \to min ( {u}_{B} , \frac{{u}_{A ∧ B}}{{l}_{( A \vert B )}} ) .$$

Then, for the conjunction A and B the lower and upper bounds are:

$${l}_{A ∧ B} \to max ( {l}_{A ∧ B} , {l}_{B} {l}_{( A \vert B )} ) ; and {u}_{A ∧ B} \to min ( {u}_{A ∧ B} , {u}_{B} {u}_{( A \vert B )} ) .$$

### J-Modulation of the Fréchet Inequalities

The PLNN includes the relative correlation coefficient parameter J which can take values in the interval [−1, 1]. This parameter modulates between maximum anti-correlation and maximum correlation given two marginal input probabilities p(P) and p(Q). For given probabilities p(P)=p and p(Q)=q, when P and Q are maximally correlated J is set to 1. When P and Q are maximally anti-correlated J is set to −1. J is quadratically interpolated so that J=0 when P and Q are statistically independent. When J=−1 and when J=1, the limits (e.g., lower and upper bounds) of the Fréchet Inequality are achieved. J is designed to have bounds in a similar manner to the various nodes, though J itself is not represented by a node in PLNN; rather there is a J (with associated bounds) associated with each operational node. If there are two input nodes P and Q, J is a mechanism for capturing prior knowledge of how the joint probability of P and Q should behave as a function of the marginal probabilities even when the marginal probabilities are loose. Bounds on J are tracked that may be tighter than the current bounds on the actual joint probability.

In the case of disjunction when J=1 the lower bound for p(P∨Q) is the max(p(P), p(Q). When J=−1 the upper bound for p(P∨Q) is the min(1, p(P)+p(Q). Thus, the limits of the Fréchet inequalities are max(p(P), p(Q)≤p(P∨Q)≤min(1, p(P)+p(Q) which illustrates the J=1 and J=−1 conditions.

In the case of conjunction, the derivation begins with the Fréchet inequalities: max(0, p(A)+p(B)−1)≤p(A∧B)=min (p(A), p(B)), where the left side corresponds to J=−1 and the right side corresponds to J=1. At J=0, the p(A∧B) should equal p(A)p(B). The following are set: (i) P_{∧, -1}=max (0, p(A)+p(B)−1, (ii) P_{∧, 0}=p(A)p(B), and (iii) P_{∧, 1}=min(p(A), p(B)). J-modulated Fréchet Inequalities for conjunction are obtained by setting:

$${P}_{∧ , - 1} ( J ) = \frac{- J ( 1 - J )}{2} {P}_{∧ , - 1} + ( 1 + J ) ( 1 - J ) {P}_{∧ , 0} + \frac{J ( 1 + J )}{2} {P}_{∧ , 1}$$

The J-Modulated Fréchet Inequalities for implication are derived similarly.

Downward Inference Revisited with the J-Modulation

The above discussion of upward and downward inferences with respect to bounds was oversimplified for explanatory purposes because the J-modulator (relative correlation coefficient) had not yet been discussed. In the more complete explanation of upward and downward inferences with respect to bounds, the relative correlation coefficient, i.e., the J-modulator, has an effect.

For an example in the case of conjunction, in the upward direction, assume that the bounds l_{A}, u_{A} are given for A and the bounds l_{B}, u_{B} are given for B. The bounds l_{J}, u_{J} are given for J with respect to A and B. The lower and upper bounds on A∧B are to be computed. The p(A∧B) is minimized at l_{A}, l_{B} and when A and B are maximally anti-correlated (which occurs with l_{J}). Also, p(A∧B) is maximized at the respective upper bounds. Thus,

$${l}_{A ∧ B} = \frac{- {l}_{J} ( 1 - {l}_{J} )}{2} max ( 0 , {l}_{A} + {l}_{B} - 1 ) + ( 1 + {l}_{J} ) ( 1 - {l}_{J} ) {l}_{A} {l}_{B} + \frac{{l}_{J} ( 1 + {l}_{J} )}{2} min ( {l}_{A} , {l}_{B} )$$

$$and$$

$${u}_{A ∧ B} = \frac{- {u}_{J} ( 1 - {u}_{J} )}{2} max ( 0 , {u}_{A} + {u}_{B} - 1 ) + ( 1 + {u}_{J} ) ( 1 - {u}_{J} ) {u}_{A} {u}_{B} + \frac{{u}_{J} ( 1 + {u}_{J} )}{2} min ( {u}_{A} , {u}_{B} )$$

Given a first group [l_{A∧B}, u_{A∧B} and l_{A}, u_{A} and l_{J}, u_{J}], the second group [l_{B}, u_{B}] is updated based on the following. Firstly considering l_{B}, as a function of p(A∧B) other quantities are fixed so that p(B) is minimized at l_{A∧B}. For fixed values of p(A∧B) and p(A), p(B) is minimized when the overlap between p(A) and p(B) is minimized. This overlap minimization happens when J is maximized, in other words at u_{J}. For fixed values of p(A∧B) and J, p(B) is minimized when P(A) is maximized, in other words at u_{A}. On the other hand to maximize p(B), all conclusions are flipped. In other words, this maximization happens at u_{A∧B}, l_{J} and l_{A}. Therefore, the following equation results:

$${l}_{A ∧ B} = \frac{- {u}_{J} ( 1 - {u}_{J} )}{2} max ( 0 , {u}_{A} + {l}_{B} - 1 ) + ( 1 + {u}_{J} ) ( 1 - {u}_{J} ) {u}_{A} {l}_{B} + \frac{{u}_{J} ( 1 + {u}_{J} )}{2} min ( {u}_{A} , {l}_{B} )$$

This equation is solved for l_{B} in terms of the known quantities l_{A∧B}, u_{A} and u_{J}. Analogously, also

$${u}_{A ∧ B} = \frac{- {l}_{J} ( 1 - {l}_{J} )}{2} max ( 0 , {l}_{A} + {u}_{B} - 1 ) + ( 1 + {l}_{J} ) ( 1 - {l}_{J} ) {l}_{A} {u}_{B} + \frac{{l}_{J} ( 1 + {l}_{J} )}{2} min ( {l}_{A} , {u}_{B} )$$

This equation is solved for u_{B} in terms of the known quantities u_{A∧B}, l_{A} and l_{J}.

In addition to updating the bounds on A or B given bounds on A∧B, J, and the other of A, B, downward inferencing also updates the bounds on J given bounds on A∧B, A, and B.

In order to update the bounds l_{J} and u_{J} given known bounds on p(A∧B), p(A), and p(B), the above two J-modulation implementing equations (for l_{A∧B} and u_{A∧B}) are used. For the l_{A∧B} equation, l_{A∧B}, u_{B}, and l_{B} are known and u_{J} is unknown. A quadratic equation with two distinct roots is obtained with u_{J} being the greater of the two values if the two values are unequal. For the u_{A∧B} equation, u_{A∧B}, l_{A}, and u_{B} are known and l_{J} is unknown. Another quadratic equation with two distinct roots is obtained with l_{J} being the greater of the two values if the two values are unequal.

The PLNN in at least some embodiments incorporates classical neural network nodes. This incorporation occurs with input nodes coming in as propositional nodes. For example, the pixels in an image classification neural network come in as propositional nodes. All other nodes from the classical neural network are operational nodes, and, in particular, disjunction nodes with the relative correlation coefficient equal to negative one. Thus, the other nodes are maximally anti-correlated disjunctions. Thus, for a classical neuron with n inputs, P(A₁∨ . . . ∨Aₙ)=min(1, p(A₁)+ . . . +p(Aₙ)—the probability of the neuron firing.

Weights in the PLNN are for edges and are trained during iterations of backward and forward propagation. In the initial specification of a PLNN, weights are typically initialized to 1 and non-unital weights are picked up in the course of PLNN computation during backward and forward propagation. Non-unital weights within a single logical operator indicate that there is something wrong with the PLNN/model that needs to be adjusted. If an operational node represents A∨B, the weights for A and B being non-unital would indicate a problem.

If a weight for A is greater than 0 and less than 1 (and the weight for B is 1) the fractional weighting indicates that too many As are included in the model of whatever is trying to be captured with the logical operator A∨B. For example, a person wants to obtain a pet as a gift for a receiving person and looks for a pet from the local animal shelter. A model could indicate the likelihood that the receiving person will be happy with the next animal to arrive at the shelter. One prior model indicated that the receiver would be happy with a cat or a dog. If A denotes the belief that the next animal to arrive will be a cat and B denotes a belief that the next animal to arrive will be a dog, then A∨B denotes the belief that the receiving person will be happy to obtain the next animal to arrive at the shelter. Over time, it is learned that the original model is incorrect because the receiving person is not happy with all types of cats but just with tabby cats. This represents a situation where A=A′∨_{(J=-1)}A″ where A′=wA and A″=(1−w)A. Thus, a correction for the model splits the probability of A among two mutually exclusive possibilities.

If a weight for A is greater than 1 (while the weight for B is 1) then a correction is also performed via the PLNN. If for the logical operator wA∨B the weight w>1, the weight being greater than one indicates that the model includes too few of the A variable. Further on the pet example, if over time it is determined that the receiving person would be happy with tabby cats or Siamese cats, the situation then correlates to the w for A being greater than 1. The input should instead be A1∨A2∨B with the tabby cat input A being split into tabby cats A1 and Siamese cats A2.

The PLNN does not have a fundamental assumption of weight aggregation that wA∨wB is the same as A∨B. Upward and downward inferencing (via forward propagation and backpropagation, respectively) also are affected by these weights. For wA∨w′ B the PLNN also handles upward and downward reasoning with weights because weights are generated in the course of operation of the PLNN.

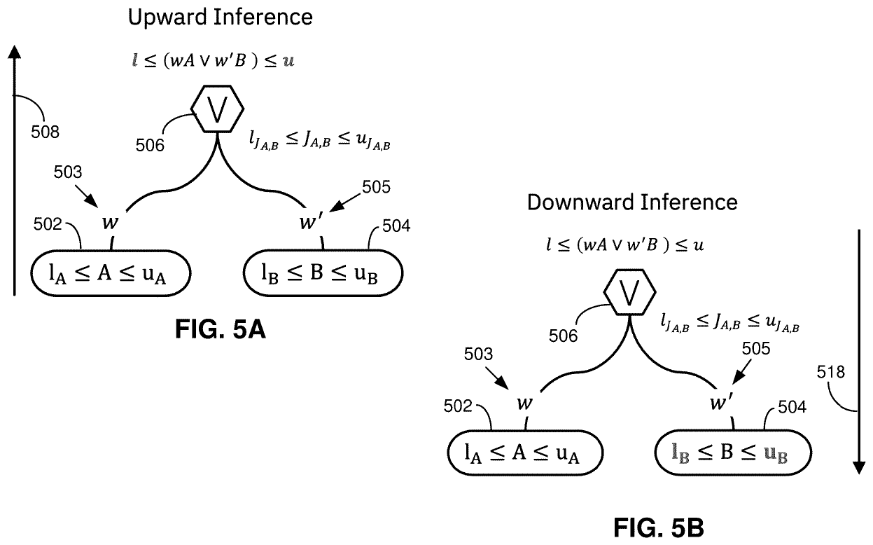

FIG. 5A shows PLNN upward inference according to at least one embodiment that is similar to the upward inference shown in FIG. 4A but also in which neural network weights are involved in the inference. The inference occurs in the upward direction 508 which refers to the feedforward direction within the PLNN. FIG. 5A shows that probability information from a left node 502 is used in conjunction with probability information from a right node 504 to determine a probability of a first disjunction logical operator 506. FIG. 5A also illustrates that a first weight 503 (w) and a second weight 505 (w′) are involved in the inference. The first weight 503 is a neural network weight related to significance of the left node 502 and/or of an edge running between the left node 502 and the first disjunction logical operator 506. The second weight 505 is a neural network weight related to significance of the right node 504 and/or of an edge running between the right node 504 and the first disjunction logical operator 506.

Given values of w and w′ and lower and upper bounds on A, B, and J, in at least some embodiments of the PLNN lower and upper bounds on wA∨w′ B are determined via the J-interpolated Fréchet inequality for a disjunction (OR). This determination yields a lower and upper bound for the associated disjunction node logical operator 506. For this purpose, wA multiplies the lower and upper bounds of A by w, with clamps at 0 and 1.

FIG. 5B shows PLNN downward inference according to at least one embodiment that is similar to the downward inference shown in FIG. 4B but also in which neural network weights are involved in the inference. The inference occurs in the downward direction 518 which refers to the backpropagation direction within the PLNN. FIG. 5B shows that, for the downward inference, probability information from the first disjunction logical operator 506 is used in conjunction with one of the left node 502 and the right node 504 to determine probability information about the other of the left node 502 or the right node 504. FIG. 5B also illustrates that the first weight 503 (w) and the second weight 505 (w′) are involved in the inference. The first weight 503 is a neural network weight related to significance of the left node 502 and/or of an edge running between the left node 502 and the first disjunction logical operator 506. The second weight 505 is a neural network weight related to significance of the right node 504 and/or of an edge running between the right node 504 and the first disjunction logical operator 506.

For the downward inference with weights, given values of wA∨w′ B and all but one lower-upper bound of the following (A, B, J), in at least some embodiments the PLNN includes inverting the J-interpolated Fréchet inequality to determine the tightest possible bound on the missing values.

The use of weights via the PLNN allows learning to be updated based on new data that is received and subsequent adjustment of weights. For example if the PLNN is implemented in a computer of a car driven by a human but with self-driving override capabilities, new data about a situation can help the PLNN learn. The PLNN initially might not recognize a set of input data regarding the vehicle and the environment as justifying a determination that an obstacle is/will be in the path and justifying application of the braking. However, if the human driver senses an obstacle under this set of data and applies the brakes, the self-driving car implementation of a PLNN can adjust the weights so that in future operation using the updated PLNN the brake is applied under a future set of similar input data.

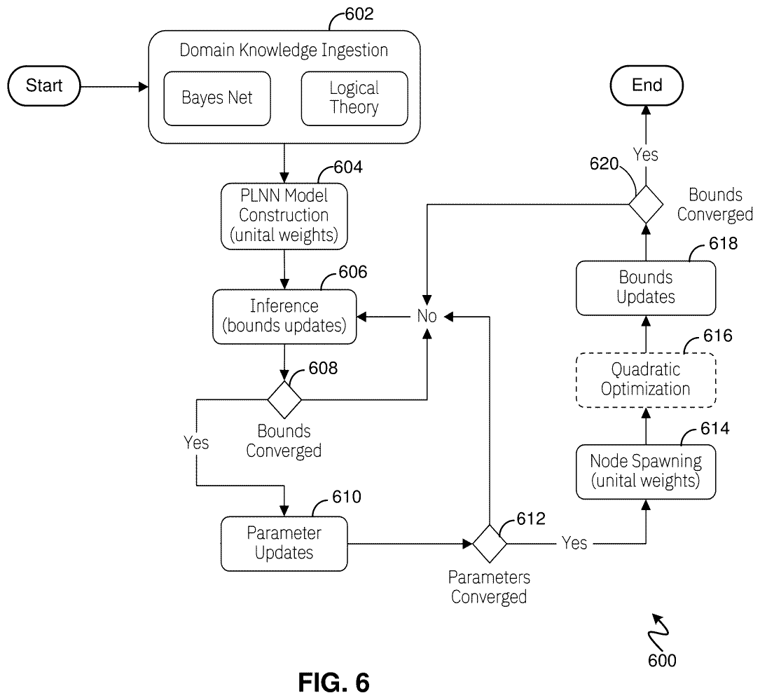

FIG. 6 illustrates a PLNN training and computation process 600 according to at least one embodiment. In step 602 of the PLNN training and computation process 600, domain knowledge is ingested. This domain knowledge includes in one example a probabilistic graphical model that represents a set of variables and their conditional dependencies via a directed acyclic graph (DAG). This domain knowledge additionally or alternatively in some examples includes logical theory about a domain. The domain can relate to logic related to an intended domain such as for logic for self-driving controls of a vehicle, power distribution in a system on a chip, etc. In step 604 of the PLNN training and computation process 600, the PLNN model is constructed and weights are initialized with unital values. The domain knowledge ingested in step 602 is used as a basis for choosing nodes and edges to establish in the PLNN. For training, a subset of the propositional nodes is designated as input nodes and a subset of the propositional and operational nodes is designated as labeled nodes. The labeled nodes represent ground truth for the particular PLNN.

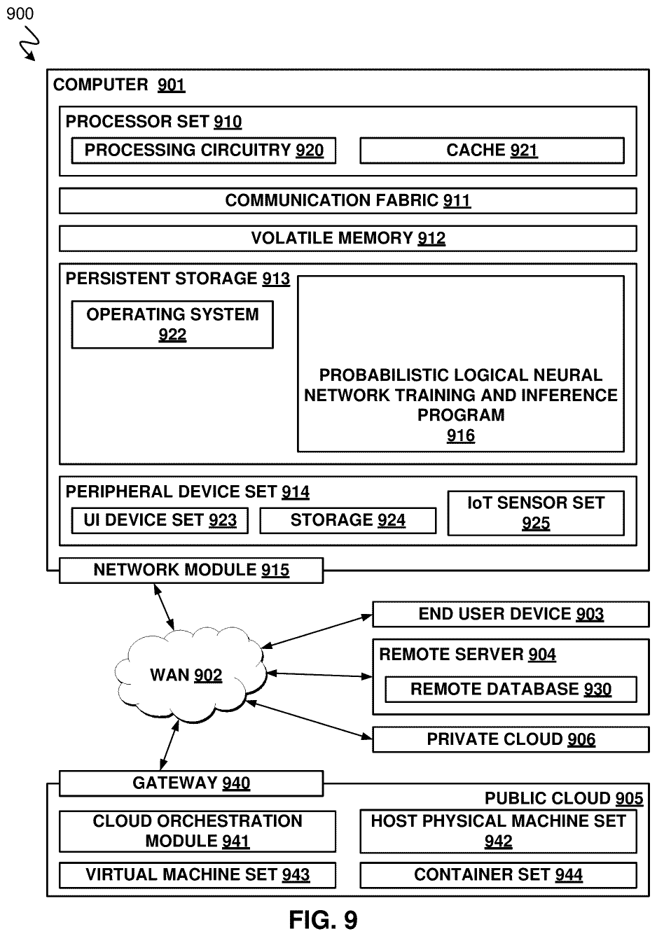

In step 606 of the PLNN training and computation process 600, inference occurs to the PLNN model that was constructed in step 604. The inference of step 606 results in updating bounds of various nodes within the PLNN. This inference includes gradient tracking within the PLNN and backpropagation. The program 916 shown in FIG. 9 performs this updating, gradient tracking, and backpropagation. This inference in some embodiments includes upwards and downwards inferencing for upper and lower bound updating as was described previously with respect to FIGS. 4A, 4B, 5A, and 5B.

In step 608 of the PLNN training and computation process 600, a determination is made whether the bounds converged. If the determination of step 608 is affirmative in that the bounds did converge, the PLNN training and computation process 600 proceeds to step 610. If the determination of step 608 is negative in that the bounds did not converge, the PLNN training and computation process 600 proceeds back to step 606 for a repeat of step 606. The bounds converge when the bounds proceed toward a minima with a decreasing trend. The training program, e.g., the probabilistic logical neural network training and inference program 916 shown in FIG. 9, analyzes the loss after each backpropagation to identify such convergence or a lack of such convergence.

This combination of steps 606 and 608 represents a first internal loop in this embodiment of the PLNN training and computation process 600. The first internal loop is exited when in step 608 it is determined that convergence occurs for the inferencing to update the bounds. After exiting the first internal loop, the PLNN training and computation process 600 proceeds to step 610.

In step 610 of the PLNN training and computation process 600, parameters are updated. These parameters include the J parameter described previously which is used for interpolation of the Fréchet inequalities.

In step 612 of the PLNN training and computation process 600, a determination is made whether the updated parameters have converged. If the determination of step 612 is affirmative in that the updated parameters did converge, the PLNN training and computation process 600 proceeds to step 614. If the determination of step 612 is negative in that the parameters did not converge, the PLNN training and computation process 600 proceeds back to step 606 for a repeat of step 606. The parameters converge when the parameters proceed toward a minima with a decreasing trend. The training program, e.g., the probabilistic logical neural network training and inference program 916 shown in FIG. 9, analyzes the loss after each backpropagation to identify such convergence or a lack of such convergence of the parameters.

This combination of steps 606, 608, 610, and 612 represents a second internal loop in this embodiment of the PLNN training and computation process 600. The second internal loop is exited when in step 612 it is determined that convergence occurs for the parameters of the PLNN such as the J parameter. After exiting this second internal loop, the PLNN training and computation process 600 proceeds to step 614.

In step 614 of the PLNN training and computation process 600, node spawning is performed to achieve unital weights. Node spawning adds a new node to the probabilistic logical graphical model. Node spawning refers to a concept of weights indicating that there are too few inputs to an operational node. Weights between 0 and 1 can indicate that there are too many inputs to an operational node. Weights greater than 1 can indicate that there are too few inputs to an operational node.

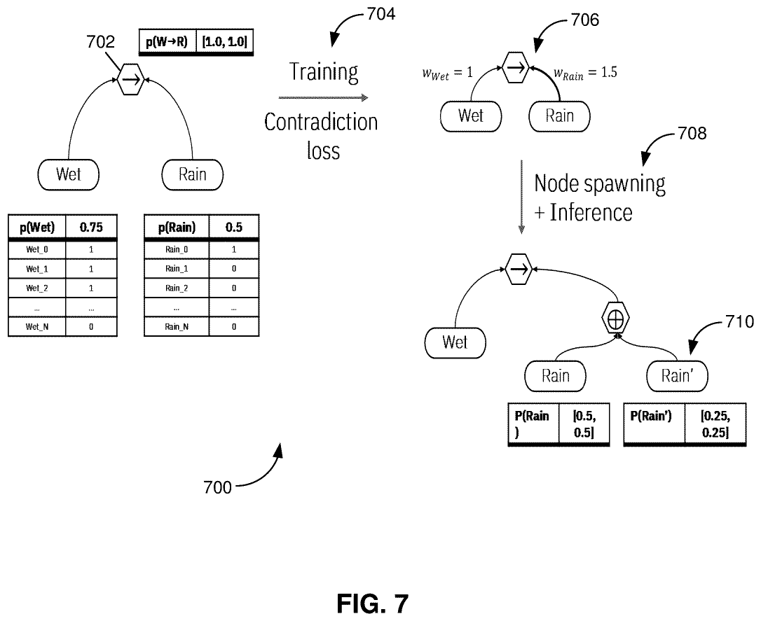

FIG. 7 describes aspects of node spawning as occurs in step 614. In the course of learning weights, a PLNN spawns off new unital weight nodes that often help with explainability. FIG. 7 shows a node spawning process 700 as it relates for an implication node 702 between wet and rain nodes, i.e., whether wetness of the grass implies rain. Thus, the wetness and the rain propositional nodes are both inputs into the implication node 702. The implication node 702 is a logical operator within an example PLNN. A small snippet of the example PLNN is shown—namely this single operational node and the nodes which directly input into this single operational node. Training 704 is performed for the PLNN including determining a contradiction loss amongst the various operational nodes. Through the training 704, the weights of the wet node and the rain node into the implication node 702 were updated to a set of weights with the rain node having a weight of 1.5 during a weight determination 706. This weight greater than 1.0 causes the PLNN and the training program 916 to recognize that an additional node should be present for splitting the rain node weight. FIG. 7 shows a node spawning step 708. The training program 916 performs the node spawning step 708 to produce a new node 710. This new node 710 accounts for a significant other cause, besides rain, for the grass becoming wet. The new node 710 is then utilized and present during training to further minimize loss of the PLNN.

In step 616 of the PLNN training and computation process 600, quadratic optimization of the PLNN is performed. This step 616 relates to optimization of the relative correlation coefficient J-modulator which is determined, as discussed above, using quadratic interpolation. This quadratic optimization also occurs in some embodiments using an external component. In some embodiments, the quadratic optimization includes message passing such as sum-product message passing.

In step 618 of the PLNN training and computation process 600, bounds are again updated based on any new nodes that were spawned in step 614 and with the PLNN having experienced quadratic optimization in step 616. These bounds include lower and upper bounds which are tightened as a result of upward and downward propagation.

In step 620 of the PLNN training and computation process 600, a determination is made whether the updated bounds have converged. If the determination of step 620 is affirmative in that the updated bounds did converge, the PLNN training and computation process 600 proceeds to end. If the determination of step 620 is negative in that the bounds did not converge, the PLNN training and computation process 600 proceeds back to step 606 for a repeat of step 606. The bounds converge when the bounds proceed toward a minima with a decreasing trend. The training program, e.g., the probabilistic logical neural network training and inference program 916 shown in FIG. 9, analyzes the loss after each backpropagation to identify such convergence or a lack of such convergence of the bounds.

This combination of steps 606, 608, 610, 612, 614, 616, 618, and 620 represents an outer loop in this embodiment of the PLNN training and computation process 600. The outer loop is exited when in step 620 it is determined that convergence occurs for the bounds of the PLNN. After exiting this outer loop, the PLNN training and computation process 600 proceeds to an end and the trained PLNN is ready for implementation to be used for inferencing.

The outer loop of the process 600 learns from data until loss is minimized. Data is injected into the input nodes. Loss is computed at the labeled nodes. Weights are updated. With the update of each weight, lower and upper bounds are tightened using upward and downward propagation until the loss is minimized.

In at least some embodiments, in the inner loops of the process 600 weights are interpreted and new nodes with unital weights are spawned off. In the inner loops, tightest possible bounds are obtained within the PLNN. The Junction Tree Algorithm is used in at least some embodiments for obtaining the tight bounds through optimization. The inner loops produce a modified PLNN with new nodes and tighter bounds. The modified PLNN is returned to the outer loop to see if the optimization of the outer loop can further minimize the loss. The outer loop performs gradient descent-guided reweighting to attempt the further minimization of loss.

The PLNN includes per node computation which allows the graph to be inspected and logs of the upward-downward inference algorithm to be inspected for a better understanding of each computational step taken towards the converged result. From a beginning of training, partial contradictions can emerge and be present in the graph. These contradictions arise because each agent involved in a multi-agent PLNN can aggregate information from multiple agents and because different agents can have different beliefs. PLNN identifies and arrests the point of contradiction and prevents the contradictions from propagating. The PLNN deduces the extent to which the contradiction violation occurs, thereby allowing partial contradictions to occur at meaningful crossing points. The PLNN follows a deterministic inference procedure to help identify which statements were involved in the contradiction compute stack. This identification allows for the graph to be inspected to identify whether the contradiction is or is not relevant to the results. (It, would not be relevant if, for example, the contradiction is present within a subgraph that is not connected to any of the output nodes or not involved in the computation thereof.) Where/when a contradiction is present in a subgraph of interest, the computational log and original directed acyclic graph can guide the training to loosen flexible nodes, e.g., observations by an agent with short-term history or observations derived by sibling agents further back in time. The identification of statements involved in the contradiction further results in relaxation of aggressive variable correlations. For example, assertions of maximal-correlation can be reduced to not include as much support from anti-correlation terms.

The use of the PLNN applies marginal and conditional probabilities and correlations between predicates to help account for noise sources and to make accurate predictive decisions. PLNN provides a framework for probabilistic inference about hidden states. PLNN combines additional domain knowledge with offline statistical data and infers predicate states to construct dynamic rules for multi-agent systems, e.g., for more optimal power sharing of components in a system on a chip.

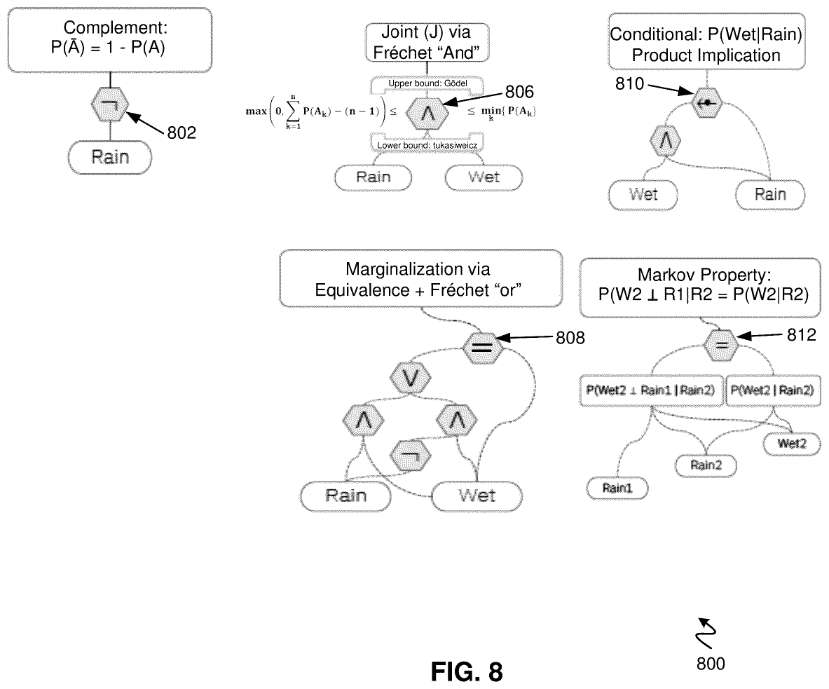

FIG. 8 illustrates a set 800 of various computational nodes and node combinations that are part of a PLNN according to at least some embodiments. In the FIG. 8 drawing, the descriptive clouds above the labeled number nodes are explanatory of the respective labeled number nodes and do not themselves represent a new node. A first computational node 802 shows a negation or complementary node whose probability is determined by one minus the probability of the affirmative assertion. A second computational node 806 shows a conjunction (joint) node via a Fréchet “And”. A third computational node 808 shows marginalization via equivalence plus a Fréchet “or” disjunction. A fourth computational node 810 shows a conditional node. A fifth computational node 812 shows a Markov property node where

$$P ( W 2 ⊥ R 1 \vert R 2 ) = P ( W 2 \vert R 2 ) .$$

In a PLNN, selective computation is performed in some embodiments with forward propagation and backpropagation using complement, joint, and conditional logical operator nodes in a first layer of operational PLNN nodes, normalization and marginalization in a second layer of operational PLNN nodes, and Markov and Bayes law operational PLNN nodes in a third layer of operational PLNN nodes.

The PLNN described herein is especially suitable for implementation in conditions of multi-agent reinforcement learning. In a system with multi-agent reinforcement learning, multiple agents coexist and compete for shared resources. The PLNN is implementable in multi-agent reinforcement learning applied to real-world problems to better perform predictions in conditions of partial observability and uncertainty. The PLNN is implemented with an event-driven formulation in which decision making is handled by distributed cooperative agents that participate in reinforcement learning and that use neuro-symbolic methods.

A system-on-chip application, e.g., a heterogeneous system-on-chip, is one example of a multi-agent environment in which the PLNN is implementable. The PLNN is able to manage power sharing of the components of the system-on-chip for adaptive runtime resource management. The system-on-chip is made up of several processing elements. Compute workloads to be executed on the system-on-chip are defined as dataflow graphs, e.g., directed acyclic graphs, connecting individual tasks that are each assigned to one specific processing element for execution based on availability by a dynamic runtime scheduler. At any given time, multiple tasks belonging to one or more workflow dataflow graphs are expected to run in parallel and the system-on-chip has a maximum allowed power envelope that all active processing elements can together consume. Because the power allocated to an active processing element determines the completion time of the task executing on the active processing element, multiple processing elements need to share the limited power resource of the system-on-chip optimally to maximize the workload throughput of the system. One reinforcement learning agent is assigned to each processing element in the system-on-chip to optimally manage the power needs of the tasks during execution so that the associated dataflow graph completes in the shortest possible time. This time optimization requires optimization of the dynamic power sharing between multiple agents based on workload conditions of the system. The PLNN helps achieve this goal using neuro-symbolic methods for interpretable rule learning and probabilistic inference under uncertainty. The reinforcement learning agent refers to a software module which represents the interests of a particular processing element.

For training a PLNN, in some embodiments a neural network is taken as input and the user is allowed to specify logical relations among various nodes of the neural network and/or to add nodes with specified logical relations to the neural network that was input. In some embodiments the neural network that is input is configured to predict latent system states under uncertainty, arising both from inherent partial observability in multi-agent reinforcement learning settings as well as from stochastic behavior of the processes that drive state variables. The PLNN additions modify the rules at runtime for a dynamic optimization solution. Cooperation between multiple agents under uncertainty and partial observability can be represented by multi-agent partially observable Markov decision processes.

A goal of system-on-chip power management is to maximize throughput (equivalent to minimize makespan), given random arrivals and completion deadlines of jobs (described by data flowgraphs). A node in a data flowgraph (job) represents a task and has to be assigned to a processing element (PE), such as a CPU, GPU, etc. With a finite number of processing elements, each processing element has an agent. A strategy for power sharing among sibling tasks at every cycle (clock time) is developed so that the total time for completing all the tasks within the data flowgraph is minimized. The agent-environment interaction includes elements of agents, state space, action space, a reward function, trajectory data, and a policy objective. A training episode includes completing a single job or workflow directed graph. The system-on-chip environment keeps track of task assignment progress of tasks, and power token distribution between tiles of the system-on-chip during lifetime of a job. At each time step the processing element tile agent takes the action of allocating a discrete percentage of maximum allowed power tokens for itself. The model was trained using a reinforce algorithm where the reward function was based on completion time of all concurrent tasks within the dataflow graph and following a standard reinforcement learning policy training setup. The reinforcement learning training was adjusted with use of first-order logical predicates and logical observations, incorporating domain expert knowledge, and controlling of admissible actions to impose guard rails. An agent could take three classes of actions in requesting share of power tokens—needing no power, needing all of the power, or needing some portion of the power. No power is needed when parent tasks are not yet completed or no tasks are assigned. All power is appropriate when a task is live and no sibling tasks are being performed simultaneously. Simultaneous sibling tasks require determination of relative importance of the tasks in order to determine an appropriate power distribution. Processing element assignments are made dynamically just in time depending on their availability. Processing element agents are in one example trained one at a time considering the other agents as part of the environment. Through the process, all agents essentially learn the same rules. In some embodiments, the neural network was configured for a five task directed flowgraph for distributing power for the system-on-chip. The neural network already showed advantages in heavy and medium system loading conditions for distributing power workload.

Ingesting the neural network that was established in that manner and creating the PLNN therewith resulted in an advancement of probabilistic inference about hidden states and more accurate predictive decisions. These achievements were at least in part due to the application of marginal and conditional probabilities and correlations between predicates to account for various sources of noise (e.g., incomplete observations by agents, variability and offsets in the execution time model, and stochasticity in workload intensity and arrival times resulting in network congestion and variation in task completion times). By applying a subset of probabilistic bounds that are available at runtime, the ingested neural network is changed to a PLNN. The PLNN significantly tightened the bounds for many nodes in the dataflow graph. In one embodiment, the PLNN adjustment occurred for light loads and the neural network adjusted to have uniform power sharing when PLNN predicted a light load. The previous power sharing rules determined were still applied when medium or heavy power sharing was predicted. This prediction of light loads by the PLNN resulted in improved target performance.

The purpose of PLNN inference, in the system-on-chip power optimization application, is for each agent to be able to predict the transient state of system variables that affect task execution times. Because there are multiple tasks sharing the system-on-chip resources, the interactions between tasks are a primary source of stochasticity in the system. These interactions are based on rate of arrival of jobs that need processing, the workload characteristics of dataflow graphs that are running, and system settings. These factors are used in constructing a probabilistic graphical model that describes cause and effect in the state of relevant system variables, and for the simplest case illustrated here, all variables only take on binary logical values (True or False) and are described by their probability of being True. Independent variables form the top layer of the probabilistic graphical model. These independent variables include a ‘High Performance Mode’ (HPM) which is a setting that determines the availability of power tokens. Hence, a True value of HPM results in a True value for the ‘Plenty of Tokens’ (POT) predicate. Other factors, such as, ‘Light Load’ (LL) in the system, or the agent task belonging to a ‘Higher Priority DAG’ (HPD), can similarly result in POT having a True state with a certain probability. POT and HPD, in turn, result in ‘Early Completion’ times (EC) with a probability. ‘Low Congestion’ (LC) refers to ease of network data communication between the processing elements. The data sharing requirements of the dataflow graphs in the system drive LC state. For example, if the ‘Other DAG Type CI’ is True, other workloads are compute intensive (not much data communication), while ‘Other DAG Type MI’ being true indicates memory intensive DAGs in the system which would predict potential network congestion and likelihood of LC being False. LC is another factor that drives Early Completion times.

Thus, domain knowledge is fed into the PLNN as logic state expectations connecting predicates to be highly correlated, anti-correlated, independent, or unknown, respectively. The values of the correlation, in relation to the J parameter can be specified and provide additional flexibility. As stronger correlations are enforced, the expected behavior is for the bounds on “loose” (uncertain) nodes to be “tightened”. However, introducing correlations that are too rigid can push many nodes in the graph into contradictions simultaneously.

In addition, based on historical data, conditional probabilities can be calculated offline and provided as an additional source of information to each agent to make system state predictions. PLNN is able to handle uncertainty in these conditional probabilities arising from uncertainty in the system state, by the use of upper and lower bounds. Each agent makes its own direct observations of different measurable predicates, for example, Early Completion, as well as aggregating Early Completion information exchanged between processing element siblings from the same dataflow graph. Domain knowledge can be injected into the agent's early completion probability estimation as heuristics that include weighting factors for freshness or staleness of information timing, diversity of workloads in the information source, etc. The agent, therefore, has access to state variable information with varying levels of certainty in the course of executing runtime tasks. The agent uses PLNN inference to predict the state of latent variables, such as light load and low congestion, which are important for its dynamic decision-making regarding power sharing. The agent may query the light load state of the system with partial information inferred for certain predicates while missing information for other ones. The reasons for missing information could be that the agent was idle and therefore its information is stale, or conflicting information from siblings does not allow reliable probability estimation. PLNN handles these uncertainties to allow the agent to make probability bounds predictions for latent state variables.

Applying PLNN starts with an instantiated graph and in some embodiments includes updating the graph using PLNN with loose J values (−1, 1) and/or updating the graph using J values from the domain knowledge. Applying PLNN-J achieves meaningful updates. Monotonically tightening the bounds has a positive effect on the probability.

In another implementation, the PLNN was applied for a collaborative autonomous vehicle with various processing elements of the vehicle. The PLNN was applied to help improve power distribution for a forty-two task dataflow graph performed by the various processing elements, e.g., four processing elements, of the collaborative autonomous vehicle. Again a neural network was ingested, and a PLNN adjustment occurred for light loads. The adjusted system resulted in uniform power sharing amongst the processing elements when PLNN predicted a light load and previous power sharing rules when medium or heavy power sharing was predicted. This prediction of light loads by the PLNN resulted in improved target performance for this application.

In another implementation, the PLNN is applicable when multiple input propositions for a collaborative autonomous vehicle are present. Such input propositions may include actuation of gas pedal, actuation of brake pedal, actuation of steering wheel, sensed obstacles in the environment, etc. By applying PLNN, some known relationships between the inputs are usable to improve predictions for unseen states in the system. In addition, with the use of weights and weight adjustments PLNN learning is also achieved. For example, driver manual override of the brake pedal teaches the PLNN model that inputs of a set of environmental information warrants determination of an obstacle and automated braking.

In another implementation, the PLNN is applicable for emergency responders responding to an unusual emergency situation. The responders do not have substantial experience of dealing with this type of emergency. Little may be known about what to expect and how to optimize between the safety of the responders and the need to stabilize the situation as quickly as possible. A big neural network is trained to take input from sensors and images and make recommendations to the first responders about what to do in real-time. The neural network learns connections between different behaviors and dangers, what actions will tend to have the largest remediation effects, and how various actions may or may not enable other actions. Training for such a system traditionally has been slow at least in part due to lack of data. However, by applying PLNN to such a neural network and using a solid logical theory behind small amounts of data, the small amounts of data are harnessed to more quickly develop a robust system that makes more accurate recommendations of what actions to take. The trustworthy probabilistic logic is programmed into the neural network and the system relies on that logic for optimizing other probabilistic logic in the PLNN.

In another implementation, the PLNN is applied to a system with temperature and pressure inputs applied as proposition nodes and other nodes as operational nodes. Logic between pressure and temperature is used within the PLNN to determine bounds and appropriate decisions based on an input pressure and temperature set.

The probabilistic logical neural network includes a framework for modeling logical relationships among probabilistically understood events and relationships. The framework includes:
(1) a set V of vertices associated with (i) elementary events without any logical connectives between them, and (ii) logical operators that act on one or more elementary events,
(2) a set E of directed edges that point from one vertex to another,
(3) a set J of relative correlation coefficients with bounds in the closed interval [−1, 1], one such correlation coefficient associated with each logical operator in the system, and
(4) a set B of belief bounds associated with each vertex in the system and each correlation coefficient J in the set J, where these bounds express the user and/or system's belief about the lower and upper bounds associated with the probability of any vertex in the system Being true, or the range of relative correlation coefficients that may be possible. In the case where the bounds are associated with a vertex in V the lower and upper bounds lie in the closed interval [0,1] with the lower bound being less than or equal to the upper bound. In the case where the bounds are associated with the range of plausible relative correlation coefficients, the lower and upper bounds lie in the closed interval [−1,1], again with the lower bound being less than or equal to the upper bound, and in at least some embodiments
(5) a set W of learnable real-valued weights that can be associated with any edge in the system.

The PLNN training program 916 takes these objects as input (with all weights typically initialized to 1) and then either (i) systematically tightens bounds as much as possible using backwards and forwards iterations of the J-modulated Fréchet Bound, or (ii) learns from data, accepting labels (a.k.a. “ground truth” values) at certain of the nodes, and successively reweighting the edges and using back-propagation from the error signal (i.e., the difference between labeled values and the predicated values) to minimize error.

The PLNN includes two distinct modes of operation:
Mode 1 (Unsupervised, unweighted) occurs whereby the system takes all of the above objects except for the weights as input and outputs tightest found bounds consistent with the input or a contradiction if the input bounds were found to be unsatisfiable. The method of mode 1 includes iteratively tightening bounds using backwards and forwards inferencing incorporating the J-modulated Fréchet inequalities to output tightest possible bounds over the various nodes in the system, or a contradiction if the input bounds were inconsistent. A contradiction is manifest in the system after successive rounds of bounds tightening with a lower bound exceeding a lower bound, either on a node of the system or the associated J parameter.
Mode 2 (Supervised, weighted) occurs whereby, in addition to the input graph, the system takes input at given propositional nodes and at designated labeled nodes, the latter of which are where it receives “ground truth” values in a training phase. Then in its operational (or test) phase, it continues to take input at the same propositional nodes and outputs predicted values at the previously labeled nodes. The method of mode 2 includes two distinct phases of operation (as indicated above), (i) a training phase and an (ii) operational or test phase.

The training phase of Mode 2 in some embodiments includes loops including an outer loop and an inner loop. The outer loop learns from data [data is injected into the input nodes and loss is computed at the labeled nodes]: weights are updated via gradient descent to minimize loss, with the process continuing until convergence. In the inner loop, (A) weights are interpreted and spawn off new (unit weight) nodes, (B) tightest possible bounds are obtained using upward and downward inferencing, and (C) network with new nodes and tighter bounds is returned to the outer loop to see if loss can be further minimized via gradient descent-guided reweighting.

The operational or test phase of Mode 2 includes using the trained PLNN by receiving fresh data at the propositional nodes (that were used for input during training). Based on the fresh data, if a propositional node is associated with an assertion about the real world, then that node clamps its bounds to [0,0] if the assertion is False or to [1,1] if the assertion is True. Then based on the new clamped values, PLNN computation is performed and predicted output for the previously labeled nodes is performed. The prediction comes in a form that includes an upper bound and a lower bound. The label is either a 0 or a 1. A loss is then computed and weights are updated using gradient descent until loss is minimized at the labeled nodes.

In some embodiments, a PLNN is formed by subsuming a Bayes Net and/or a Logical Credal Net. This subsuming is an automated process for taking these models as input and converting the models to PLNN. The resultant PLNN graph is much larger than the associated Bayes Net graph or the associated Logical Credal Net graph. For example, each row in a Bayes Net or Credal Net conditional probability table corresponds to several nodes of a PLNN. The implied independencies and conditional independencies in a Bayes Net or Credal Net graph also give rise to additional nodes. The PLNN that is formed allows inference to be performed in ways that are different from the ways that the subsumed Bayes or Credal Net performed inference. The input to a PLNN is the entire graph together with bounds on each of the vertices and each of the J-modulated parameters. If completely unknown, the probability bounds are initialized to [0, 1] and the J bounds to [−1, 1]. If learning is done from data, then labeled nodes are chosen and ground truth labels are supplied for some data stream(s).

The PLNN has special success when used with modest-sized probabilistic-logical theories, especially when used in conjunction with an existing neural network.

PLNN activations are straight-forward to implement, using weighted rectified linear unit activation functions (ReLUs) and max/min functions. Convergence of the inner loop, associated with successive tightening of the Fréchet bounds, using forward and backward inferencing, is guaranteed due to monotonicity. If a pure gradient descent is performed, a local extremum is determined, at least within the numerical precision of the computer. If controlled perturbation is implemented for the training, a better local extremum (or conceivably the optimal solution) is determined.

The PLNN represents a structured way of incorporating domain knowledge that is embedded and interpretable directly outside of the model. PLNN nodes are probabilistic-symbolic and not black box nodes. The PLNN also learns to adjust the domain knowledge over time so that if the domain knowledge is not quite right (e.g., not in agreement with the given data). This adjustment can occur via probability adjustment and/or node spawning, etc. For the PLNN, the advantage is achieved that logic does not have to be associated with output nodes but can be associated with any of the nodes in the PLNN. Thus, any and/or all nodes of the PLN are output nodes or potentially are output nodes.

It may be appreciated that FIGS. 1-8 provide only illustrations of certain embodiments and do not imply any limitations with regard to how different embodiments may be implemented. Many modifications to the depicted embodiment(s), e.g., to the particular steps and/or order of depicted methods or components of a neural network, may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 900 contains an example of an environment for the execution of at least some of the computer code involved in performing the inventive methods, such as probabilistic logical neural network training and inference program 916. In addition to probabilistic logical neural network training and inference program 916, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and probabilistic logical neural network training and inference program 916, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in probabilistic logical neural network training and inference program 916 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface-type operating systems that employ a kernel. The code included in probabilistic logical neural network training and inference program 916 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing exceptionally large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN 902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901) and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EID 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

The computer 901 is in some embodiments a server. The remote server 904 in some embodiments represents multiple servers which provide machine learning resources and/or computer memory resources for the computer 901 and the probabilistic logical neural network training and inference program 916.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The flowchart and block diagrams in the Figures illustrate the architecture, functionality, and operation of possible implementations of systems, methods, and computer program products according to various embodiments. In this regard, each block in the flowchart, pipeline, and/or block diagrams may represent a module, segment, or portion of instructions, which comprises one or more executable instructions for implementing the specified logical function(s).

What is claimed is:

1. A computer-implemented method comprising:
performing inferencing with a probabilistic logical neural network, the probabilistic logical neural network comprising a probabilistic graphical model comprising propositional nodes, logical operational nodes, and directed edges, wherein the probabilistic logical neural network implements upward and downward inference, the directed edges indicate a direction of upward inference, the downward inference is in an opposite direction from that of the directed edges, the propositional and logical operational nodes are coupled with respective belief bounds, and each logical operational node comprises a respective activation function set to a probability-respecting generalization of Fréchet inequalities.

2. The computer-implemented method of claim 1, wherein the propositional nodes are associated with assertions.

3. The computer-implemented method of claim 1, wherein the directed edges respectively point from a propositional node to a logical operational node or from one logical operational node to another logical operational node.

4. The computer-implemented method of claim 1, wherein the logical operational nodes incorporate relative correlation coefficients bounded in a range of [−1, 1] that modulate the Fréchet inequalities, and wherein the relative correlation coefficients are taken as input and provided as output at the logical operational nodes, respectively.

5. The computer-implemented method of claim 4, wherein the relative correlation coefficients interpolate between a maximum anti-correlation represented by −1, statistical independence represented by 0, and maximum correlation represented by 1.

6. The computer-implemented method of claim 1, wherein for each node of the probabilistic logical neural network the belief bounds comprise a lower bound and an upper bound, wherein the lower bound and the upper bound are both greater than or equal to zero and less than or equal to one.

7. The computer-implemented method of claim 1, wherein the probabilistic logical neural network includes a respective weight for each of the directed edges, wherein the weights are initialized to a value of 1 and adjusted during successive iterations of training.

8. The computer-implemented method of claim 1, further comprising performing node spawning during training in response to identifying non-unital weights amongst inputs, the node spawning adding a new node to the probabilistic graphical model.

9. The computer-implemented method of claim 8, wherein the node spawning is performed in an inner loop of the training and additional loss minimization is performed in an outer loop of the training.

10. The computer-implemented method of claim 1, wherein the logical operational nodes comprise one or more implication nodes indicating beliefs about conditional probabilities between two or more inputs.

11. The computer-implemented method of claim 1, further comprising forming the probabilistic logical neural network via:
receiving the propositional nodes, the logical operational nodes, and the belief bounds as input, initializing weights, and
systematically tightening the belief bounds using iterations of upward and downward inference iteratively applying J-modulated Fréchet bounds.

12. The computer-implemented method of claim 11, wherein the receiving occurs via ingesting a neural network.

13. The computer-implemented method of claim 1, further comprising forming the probabilistic logical neural network via receiving the propositional nodes, the logical operational nodes, and the belief bounds as input, initializing weights, identifying some of the logical operational and propositional nodes as ground truth, and adjusting the weights using backpropagation to minimize loss based on the ground truth.

14. The computer-implemented method of claim 1, wherein the inferencing comprises receiving new data at the propositional nodes, clamping values of the propositional nodes based on the received new data, and predicting output made at previously labelled nodes.

15. A computer system comprising:
one or more processors, one or more computer-readable memories, and program instructions stored on at least one of the one or more computer-readable memories for execution by at least one of the one or more processors to cause the computer system to:
perform inferencing with a probabilistic logical neural network, the probabilistic logical neural network comprising a probabilistic graphical model comprising propositional nodes, logical operational nodes, and directed edges, wherein the probabilistic logical neural network implements upward and downward inference, the directed edges indicate a direction of the upward inference, the downward inference is in an opposite direction to that of the directed edges, the proposition and logical operator nodes are coupled with respective belief bounds, and each logical operator of the logical operator nodes comprises a respective activation function set to a probability-respecting generalization of Fréchet inequalities.

16. The computer system of claim 15, wherein the operational nodes incorporate relative correlation coefficients bounded in a range of [−1, 1] that modulate the Fréchet inequalities, and wherein the relative correlation coefficients are taken as input and provided as output at the operational nodes, respectively.

17. The computer system of claim 15, wherein the probabilistic logical neural network includes a respective weight for each of the directed edges, wherein the training comprises initializing the weights to a value of 1 and adjusting the weights during passes of the training.

18. A computer program product comprising a computer-readable storage medium having program instructions embodied therewith, the program instructions executable by a computer to cause the computer to:
perform inferencing with a probabilistic logical neural network, the probabilistic logical neural network comprising a probabilistic graphical model comprising propositional nodes, logical operational nodes, and directed edges, wherein the probabilistic logical neural network implements upward and downward inference, the directed edges indicate a direction of upward inference, the downward inference is in an opposite direction from that of the directed edges, the proposition and logical operational nodes are coupled with respective belief bounds, and each logical operator of the operational nodes comprises a respective activation function set to a probability-respecting generalization of Fréchet inequalities.

19. The computer program product of claim 18, further comprising performing node spawning during training in response to identifying non-unital weights amongst inputs, the node spawning adding a new node to the probabilistic graphical model.

20. The computer program product of claim 18, wherein the probabilistic logical neural network includes a respective weight for each of the directed edges, wherein the training comprises initializing the weights to a value of 1 and adjusting the weights during passes of the training.
